(19) United States
(12) Patent Application Publication
(10) Pub. No.: US 2022/0239671 A1
(43) Pub. Date: Jul. 28, 2022

(54) IMPEDING FORECAST THREAT PROPAGATION IN COMPUTER NETWORKS

(71) Applicant: BRITISH TELECOMMUNICATIONS PUBLIC LIMITED COMPANY, LONDON (GB)

(72) Inventors: Xiao-Si WANG, London (GB); Zhan cui, London (GB); Jonathan TATE, London (GB)

(21) Appl. No.: 17/596,984

(22) PCT Filed: Jun. 24, 2020
(86) PCT No.: PCT/EP2020/067652

§ 371 Date: Dec. 22, 2021

(30) Foreign Application Priority Data
Jun. 30, 2019 (EP) 19183512.3

(51) Int. Cl. H04L 9/40

(52) U.S. Cl. CPC H04L 63/145

(57) ABSTRACT

A computer implemented method to block malware propagation in a network of computer systems by receiving, for each of a plurality of time periods, a historical model of the network of computer systems identifying communications therebetween and a malware infection state of each computer system; generating, for each of a plurality of subsequent time periods, a forecast model of the network of computer systems in which each forecast model identifies communications between computer systems and malware infection state of computer systems being determined based on an extrapolation of the set of historical models; identifying a common resource in the network involved in propagation of the malware, the identification being based on changes to malware infection states of computer systems and the communications therebetween identified in the forecast models; and implementing protective measures in respect to the common resource so as to block propagation of the malware through the network.

### PRIORITY CLAIM

The present application is a National Phase entry of PCT Application No. PCT/EP2020/067652, filed Jun. 24, 2020, which claims priority from EP Patent Application No. 19183512.3, filed Jun. 30, 2019, each of which is hereby fully incorporated herein by reference.

### TECHNICAL FIELD

The present disclosure relates to impeding the propagation of a threat through computer networks.

### BACKGROUND

Malicious software, known as malware, threatens computer systems communicating via computer networks. Malware can be propagated between computer systems across communications links such as physical, virtual, wired or wireless network communications. As computer systems within a network are infected with malware, a rate of spread of malware can increase presenting a threat to potentially all network-connected devices.

Thus, there is a challenge in providing an effective approach to impeding the propagation of such threats within computer networks.

### SUMMARY

According to a first aspect of the present disclosure, there is a provided a computer implemented method to block malware propagation in a network of computer systems, the method comprising: receiving, for each of a plurality of time periods, a historical model of the network of computer systems identifying communications therebetween and a malware infection state of each computer system; generating, for each of a plurality of subsequent time periods, a forecast model of the network of computer systems in which each forecast model identifies communications between computer systems and malware infection state of computer systems being determined based on an extrapolation of the set of historical models; identifying a common resource in the network involved in propagation of the malware, the identification being based on changes to malware infection states of computer systems and the communications therebetween identified in the forecast models; and implementing protective measures in respect to the common resource so as to block propagation of the malware through the network.

In one embodiment, the common resource is one of a computer system in the network; and a network element in the network.

In one embodiment, the network element includes one or more of: a network appliance; a router; a switch; a bridge; a domain name server; a proxy; a gateway; an access point; a network interface card; a repeater; and a virtualized network device.

In one embodiment, identifying a common resource includes performing a plurality of correlation processes, each correlation process correlating one or more of: data about communications between computer systems in the network; and malware infection states of computer systems, the common resource being identified based on the correlations.

In one embodiment, data about communications between computer systems includes one or more of: characteristics of communications between computer systems in the network; characteristics of endpoints of communications between computer systems in the network; changes to communication characteristics over time.

In one embodiment, malware infection states of computer systems include: an infected state in which a computer system is subject to a malware infection; a vulnerable state in which a computer system is susceptible to malware infection; and a remediated state in which a computer system is remediated of a malware infection.

In one embodiment, the method further comprises: identifying, for a network appliance in the computer network through which a set of sub-networks of the network communicate, a sub-network in which a proportion of computer systems infected by the malware meets a predetermined threshold; and responsive to the identification, implementing protective measures in respect to the network appliance so as to block propagation of the malware through the appliance.

In one embodiment, the protective measures include performing an action in respect of the common resource, wherein the action includes one or more of: reconfiguring the common resource; disconnecting the common resource; precluding access to the common resource by at least a subset of computer systems in the network; and applying an anti-malware service to the common resource, so as to block propagation of the malware.

In one embodiment, each of the historical and forecast models is a graph data structure having computer systems as nodes and communications therebetween as edges.

According to a second aspect of the present disclosure, there is a provided a computer system including a processor and memory storing computer program code for performing the method set out above.

According to a third aspect of the present disclosure, there is a provided a computer system including a processor and memory storing computer program code for performing the method set out above.

### BRIEF DESCRIPTION OF THE FIGURES

Embodiments of the present disclosure will now be described, by way of example only, with reference to the accompanying drawings, in which:

FIG. 1 is a block diagram a computer system suitable for the operation of embodiments of the present disclosure.

FIG. 2 is a component diagram of an arrangement for blocking malware propagation in a network in accordance with an embodiment of the present disclosure.

FIG. 3 depicts an illustrative embodiment for identifying a common resource according to the arrangement of FIG. 2 in accordance with an embodiment of the present disclosure.

FIG. 4 is a flowchart of a method to block malware propagation in a network according to an embodiment of the present disclosure.

FIG. 5 is a component diagram of an arrangement for blocking malware propagation in a network using location information according to an embodiment of the present invention;

FIG. 6 is a flowchart of a method to block malware propagation in a network using location information according to an embodiment of the present disclosure.

FIG. 7 is a component diagram of an arrangement for blocking malware propagation in a network using a forecast model of the network according to an embodiment of the present disclosure.

FIG. 8 is a flowchart of a method to block malware propagation in a network using a forecast model of the network according to an embodiment of the present disclosure.

### DETAILED DESCRIPTION

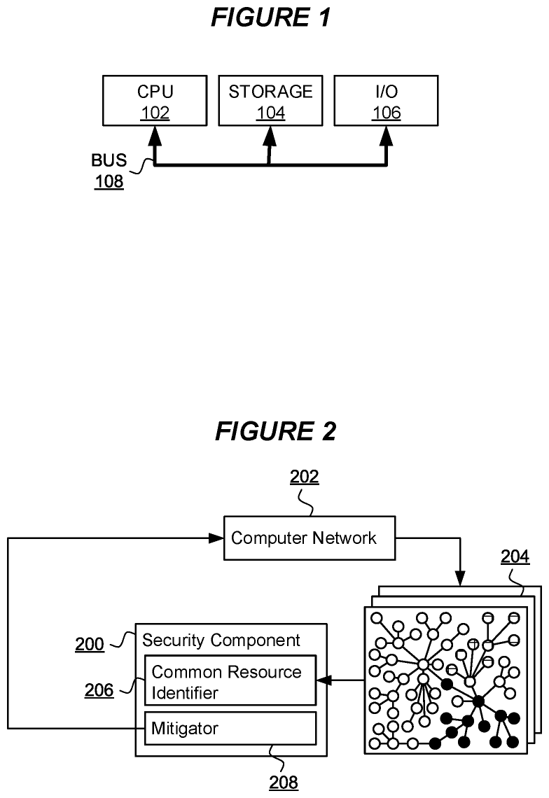

FIG. 1 is a block diagram of a computer system suitable for the operation of embodiments of the present disclosure. A central processor unit (CPU) 102 is communicatively connected to a storage 104 and an input/output (I/O) interface 106 via a data bus 108. The storage 104 can be any read/write storage device such as a random-access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

FIG. 2 is a component diagram of an arrangement for blocking malware propagation in a network in accordance with an embodiment of the present disclosure. A computer network 202 is a means for communication between a each of a plurality of computer systems such as a wired, wireless, cellular, physical, virtualized or logical network or a network comprised of two or more such arrangements as will be apparent to those skilled in the art. Communicating computer systems include physical and/or virtualized computer systems communicatively connected to the network 202 such as via network interface hardware, virtualized hardware or other suitable means. Computer systems may be connected physically (or in a virtualization of a physical manner) to one network while being logically connected to another network such as through a tunneling, virtual network, virtual private network (VPN) or other suitable technology. A particular topology, technology or arrangement of the network 202 is not significant.

A security component 200 is provided as a hardware, firmware, software or combination component arranged to provide security services for the network 202. The security component 200 can be provided as a dedicated physical or virtualized computer system or device, such as a network appliance, apparatus or the like in communication with the network 202. Alternatively, the security component 200 can be provided as a facility, service or function of one or more devices in the network 202 such as network appliances. For example, the security component 200 can be provided as part of a router, switch, gateway, proxy, access point, hub or other network appliances, any or all of which can be virtualized.

The security component 200 is operable to provide services for impeding the propagation of malware between computer systems in the network 200 by blocking malware propagation as will be described below. The security component 200 receives a model 204 of the network of computer systems for each of a plurality of time periods. Thus, the model can be described as a temporal model. For example, a model can be received for each time period according to a predefined schedule. Alternatively, a model can be received for a time period according to one or more trigger conditions such as a security event including a detection of malware within the network. Each model 204 identifies communications between computer systems within the network 202 so as to indicate paths of communication between the computer systems. Additionally, each model 204 identifies, for each computer system represented in the model, a malware infection state of the computer system. In one embodiment, malware infection states indicated in a model for a time period include: an infected state in which a computer system is subject to malware infection during the time period; a vulnerable state in which a computer system is not subject to a malware infection but is also not protected from, or remediated of, the malware infection during the time period; and a remediated state in which a computer system has been remediated of a prior malware infection. In a preferred embodiment, the models are provided as one or more graph data structures in which computer systems are indicated as stateful nodes in a graph with communications therebetween indicated as edges between nodes. For example, the illustrative model 204 depicted in FIG. 2 includes nodes representing computer systems with edges representing network communications. Further, each node in FIG. 2 indicates its malware infection state such that a hatched node is remediated, a black node is infected and a white node is vulnerable.

The models 204 can be specifically generated for the network by a modelling, reporting, analysis or other suitable component. For example, determination of computer systems in the network can be made by monitoring network traffic or through predefined network topology or configuration information. Further, communication between such systems can be determined based on network traffic such as routing information, traffic target/destination information and the like. A malware infection state of each computer system can be provided by, for example, security services provided with or for each computer system such as anti-malware services. Such services can determine, based on malware detection rules, the existence of malware within a computer system (a state of infected). Similarly, a remediation of malware can indicate a state of remediated. The identification of computer systems being in a vulnerable state can be determined using a conservative approach to include computer systems being in neither the infected nor remediated states, for example.

The security component 200 includes a common resource identifier 206 as a hardware, software, firmware or combination component for identifying a common resource in the network 202 involved in the propagation of malware. Resources in the network 202 include hardware, software, firmware or combination components such a network elements or computer systems themselves. A network element in the network 202 can include, for example: a network appliance; a router; a switch; a bridge; a domain name server; a proxy; a gateway; an access point; a network interface card; a repeater; a virtualized network device, and/or other network elements as will be apparent to those skilled in the art. Thus, the common resource identifier 206 is operable to identify a resource in the network 204 that is involved in the propagation of malware and in respect of which protective measures can be implemented so as to block the propagation of the malware. Thus, a mitigator component 208 is provided as a hardware, firmware, software or combination component for deploying protective measures for the network 202 to block propagation of malware.

For example, a network appliance identified as a resource common to communication by multiple infected computer systems in the network 202 can be identified as a common resource involved in the propagation of malware. Protective measures deployed by the mitigator 208 can include, inter alia: precluding access to the appliance; de-provisioning the appliance; reconfiguring the appliance; disconnecting the appliance; precluding access to the common resource by at least a subset of the computer systems; applying an anti-malware service to the common resource; and other protective measures as will be apparent to those skilled in the art. Further notably, protective measures in respect of an identified common resource can include malware remediation and/or protection deployed at computer systems themselves where the computer systems are involved in communication with, or via, the identified common resource.

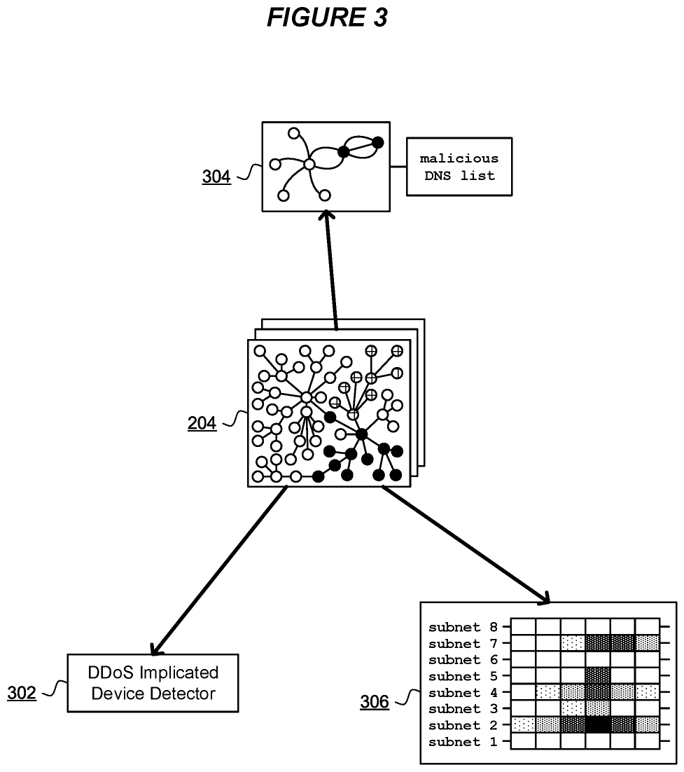

In one embodiment, the common resource identifier 206 identifies the common resource based on a plurality of correlation processes, each of which correlates one or more of: data about communications between computer systems in the network; and malware infection states of computer systems in the network. Data about communications between computer systems can include one or more of: characteristics of communications between computer systems; characteristics of endpoints of communications between computer systems; and changes to communication characteristics over time (i.e. across multiple models). Examples of such correlation will be described below with respect to FIG. 3.

In one embodiment, the network 202 is comprised of a plurality of sub-networks such as subnets, and the security component 202 is additionally operable to identify a subnet in which a proportion computer systems communicating via the subnet that are in an infected state exceeds a predetermined threshold. Responsive to such an identification, the security component 202 implements protective measures in respect of a network appliance through which communications via the identified subnet pass.

Thus, in use, the security component 200 is operable to identify a common resource in the network 202 involved in the propagation of malware through the network 202, and to implement protective measures to block propagation of the malware through the network 202.

FIG. 3 depicts an illustrative embodiment for identifying a common resource according to the arrangement of FIG. 2 in accordance with an embodiment of the present disclosure. In the arrangement of FIG. 3, correlations of data based on the temporal models 204 are performed in three ways. A threat being monitored in the illustrative embodiment of FIG. 3 is the propagation of malware in a logical network where each node represents a computer system each edge indicates that two nodes directly communicate with each other via a network 202.

According to one exemplary correlation, the network 202 is comprised of a plurality of subnets and identifiers of infected computer systems can be correlated against subnets of the network 202 over time to generate a heat map 306 as a data structure representation of a degree of infection of subnets over time. The horizontal axis of the heatmap 306 corresponds to the progression of time and the vertical axis corresponds to each subnet in the network 202. Darker portions of the heatmap indicate greater extent of infection by computer systems within a corresponding subnet. The correlation by way of the heatmap 306 serves to identify subnets (and, therefore, resources of such subnets) involved in the propagation of the malware over time. Further, the route of propagation between subnets can be determined, so serving to identify a common network resource involved in such propagation over time.

A second exemplary correlation uses identifiers of infected computer systems correlated against request pathway data 304 such as server and URL (uniform resource locator) information over a corresponding period of time or a longer period of time in case some events shown in a device request data were linked to the devices being infected subsequently. All URLs involved in request data of infected computer systems can then be correlated with data identifying known malicious domain name service (DNS) servers to identify one or more malicious DNS servers accessed by the computer systems during the malware propagation. Such a DNS server would thus constitute a common resource.

A third exemplary correlation uses identifiers of infected computer systems correlated with computer system connection data to determine which systems may be launching superfluous requests in a short period of time. Such behavior can indicate a source of distributed denial-of-service (DDoS) attack and provides for an identification of events leading to such an attack. In particular, malware infection is a common technique used to launch a DDoS attack. If a malware infection is not treated, seeking to address the symptoms of a DDoS attack may not be sufficient because entities with malicious control of infected computer systems can persist in their use of such systems to launch new DDoS attacks.

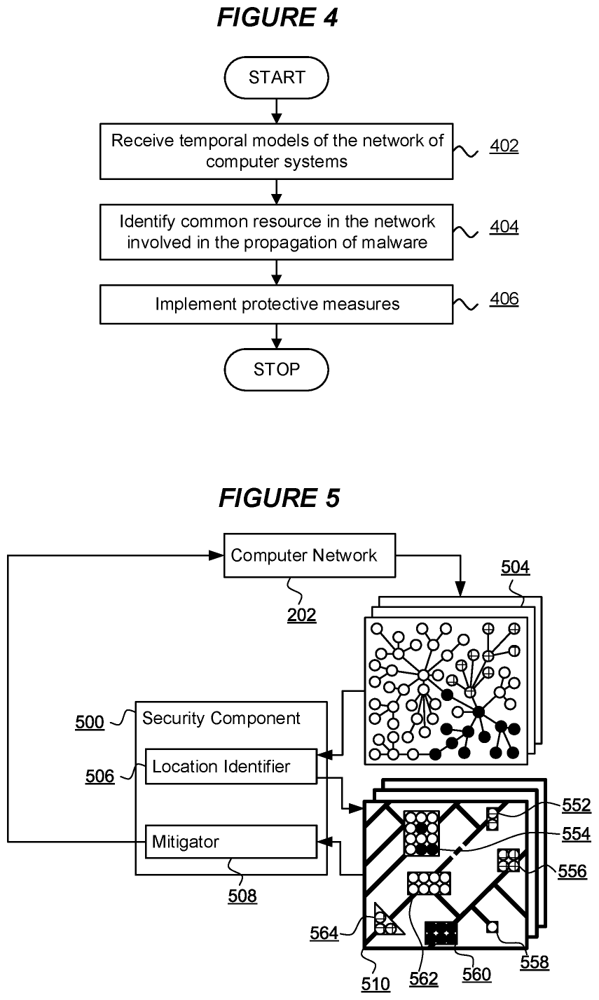

FIG. 4 is a flowchart of a method to block malware propagation in a network according to an embodiment of the present disclosure. Initially, at 402, the method receives, for each of a plurality of time periods, a model of the network of computer systems identifying communications therebetween and a malware infection state of each computer system. At 404 the method identifies a common resource in the network involved in propagation of the malware, the identification being based on changes to malware infection states of computer systems and the communications therebetween identified in the models. At 406, the method implements protective measures in respect to the common resource so as to block propagation of the malware through the network.

Conventional network-wide malware detection and mitigation measures can be undertaken on a topological basis since network components (devices, appliances, etc.) may be considered to communicate in accordance with the topology on the network. However, the ability for devices to traverse a network topology and “switch” between networks introduces new challenges for malware propagation control. For example, a singular physical or virtual computer system can switch between multiple networks using virtual private network (VPN) connections or the like, by switching virtualized network configurations (e.g. adding/removing virtual network interface cards (NICs) and virtual network connections that may themselves be provided by an underlying VPN or the like), or by physically changing network (especially as devices are increasingly mobile). Thus, a single device may, momentarily, appear to be communicating via a first network but may subsequently communicate via a second network. Such changes undermine normal malware propagation controls which typically assume ongoing adherence to a fixed network topology.

An embodiment of the present disclosure seeks address these challenges by employing location information indicating a physical location of a computer system. FIG. 5 is a component diagram of an arrangement for blocking malware propagation in a network using location information according to an embodiment of the present disclosure. Many of the elements of FIG. 5 are identical to those described above with respect to FIG. 2 and these will not be repeated here. FIG. 5 includes a location identifier 506 as a hardware, firmware, software or combination component operable to identify location information indicating a physical location for computer systems represented in the models 504. A physical location of a computer system can be indicated as a geolocation, such as a particular location in geospace. Additionally or alternatively, a physical location can be indicated as a location within a site, building, type of building, container, type of container, relative location or other locations as will be apparent to those skilled in the art.

In one exemplary embodiment, the location identifier 506 is operable to generate a map 510 for each temporal model 504 indicating physical locations of computer systems in the model. Notably, the malware infection state of each computer system in the map 510 can be retained, referenced or discerned. The exemplary map 510 of FIG. 5 illustrates twelve computer systems in an infected state of which six are collocated at 560 in the map. A further three systems are collocated with nine vulnerable systems at 554. Further, three groups of remediated systems are indicated at 552, 556 and 564, with one further group of vulnerable systems (comprising a single computer system) at 558. Notably, a map 510 such as that depicted in FIG. 5 (or other such suitable representation, record or indication of physical location information for computer systems) is provided for each temporal model 504 such that multiple maps are provided over time.

The location identifier 506 identifies a physical location at which one or more computer systems are involved in propagation of the malware. The physical location involved in propagation is identified based on colocation of computer systems as indicated in the map 510. Further, the physical location is identified based changes to malware infection states of computer systems and communications therebetween, as described above with respect to FIG. 2. This, in this way, a location involved in the propagation of malware can be detected and protective measures can be deployed in respect of the identified physical location. For example, in the illustrative example of FIG. 5, over time the infection of computer systems at location 554 can be detected to trigger protective measures for devices and systems at location 554 so as to block the propagation of malware at that location. Additionally, proximate locations to the identified location can be protected also, such as location 562 which includes vulnerable computer systems.

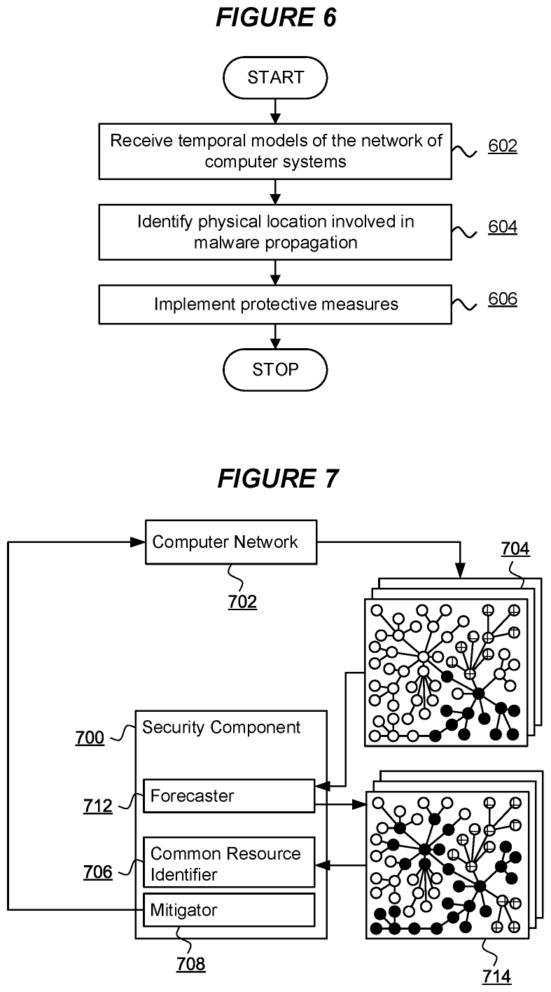

FIG. 6 is a flowchart of a method to block malware propagation in a network using location information according to an embodiment of the present disclosure. Initially, at 602, the method receives, for each of a plurality of time periods, a model of the network of computer systems identifying communications therebetween and a malware infection state of each computer system. At 604 a physical location at which one or more computer systems are involved in propagation of the malware is identified. The identification at 604 is based on changes to malware infection states of computer systems; colocation of computer systems and the communications therebetween identified in the models. At 606, protective measures are implemented in respect to the physical location so as to block propagation of the malware through the network.

FIG. 7 is a component diagram of an arrangement for blocking malware propagation in a network using a forecast model of the network according to an embodiment of the present disclosure. Many of the elements of FIG. 7 are identical to those described above with respect to FIG. 1 and these will not be repeated here. FIG. 7 is enhanced vis-à-vis FIG. 1 by the provision of a forecaster component 712 as a hardware, firmware, software or combination component operable to generate forecast models 714 for computer systems in the network 702. The forecaster component 712 receives the temporal models 704 and, based thereon, forecasts network communication and states of infection for computer systems for a plurality of time periods into the future. Thus, each of the forecast models 714 corresponds to a future time period subsequent to the temporal models 704, which can be considered historical models 704. In one embodiment, the forecast models 714 are defined based on an extrapolation of the historical models 704 such that the propagation of malware and the malware infection state of computer systems is predicted by the forecaster 712 based on historical communications between computer systems, the historical malware infection status of computer systems, and how those change over time in the historical models 704.

Accordingly, in the arrangement of FIG. 7, the common resource identifier 706 is operable as described above with respect to FIG. 1 except that it is operable on the basis of the forecast models 714 such that predicted future state of the network 702 is used to identify a common resource for which protection measures are taken by the mitigator 708. In this way, a future propagation of the malware can be blocked in anticipation.

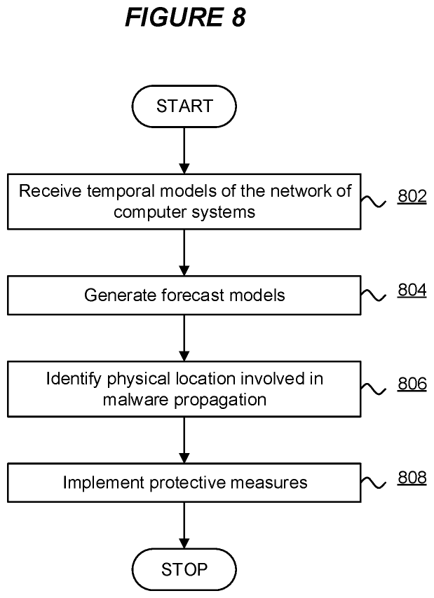

FIG. 8 is a flowchart of a method to block malware propagation in a network using a forecast model of the network according to an embodiment of the present disclosure. Initially, at 802, the method receives, for each of a plurality of time periods, a historical model of the network of computer systems identifying communications therebetween and a malware infection state of each computer system. At 804 the forecaster 712 generates, for each of a plurality of subsequent time periods, a forecast model 714 of the network 702 of computer systems in which each forecast model 714 identifies communications between computer systems and malware infection state of computer systems being determined based on an extrapolation of the set of historical models 704. At 806 the method identifies a common resource in the network 702 involved in propagation of the malware, the identification being based on changes to malware infection states of computer systems and the communications therebetween identified in the forecast models 714. At 808 the method implements protective measures in respect to the common resource so as to block propagation of the malware through the network 702.

Insofar as embodiments of the invention described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present disclosure. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure.

It will be understood by those skilled in the art that, although the present disclosure has been described in relation to the above described example embodiments, the disclosure is not limited thereto and that there are many possible variations and modifications which fall within the scope of the disclosure.

The scope of the present disclosure includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method to block malware propagation in a network of computer systems, the method comprising:
receiving, for each of a plurality of time periods, a historical model of the network of computer systems identifying communications between the computer systems and a malware infection state of each computer system;
generating, for each of a plurality of subsequent time periods, a forecast model of the network of computer systems in which each forecast model identifies communications between the computer systems and a malware infection state of the computer systems being determined based on an extrapolation of the historical models;
identifying a common resource in the network involved in propagation of the malware, the identification being based on changes to the malware infection states of the computer systems and the communications between the computer systems identified in the forecast models; and
implementing protective measures in respect to the common resource so as to block propagation of the malware through the network.

2. The method of claim 1, wherein the common resource is one of a computer system in the network or a network element in the network.

3-10. (canceled)

11. The method of claim 2, wherein the network element includes one or more of: a network appliance; a router; a switch; a bridge; a domain name server; a proxy; a gateway; an access point; a network interface card; a repeater; and a virtualized network device.

12. The method of claim 1, wherein identifying a common resource includes performing a plurality of correlation processes, each correlation process correlating one or more of: data about communications between the computer systems in the network, and malware infection states of the computer systems, the common resource being identified based on the correlations.

13. The method of claim 12, wherein the data about communications between the computer systems includes one or more of: characteristics of communications between the computer systems in the network; characteristics of endpoints of the communications between the computer systems in the network; and changes to the communication characteristics over time.

14. The method of claim 12, wherein malware infection states of the computer systems include: an infected state in which a computer system is subject to a malware infection; a vulnerable state in which a computer system is susceptible to malware infection; and a remediated state in which a computer system is remediated of a malware infection.

15. The method of claim 1, further comprising:
identifying, for a network appliance in the computer network through which a set of sub-networks of the network communicate, a sub-network in which a proportion of the computer systems infected by the malware meets a predetermined threshold; and
responsive to the identification, implementing protective measures in respect to the network appliance so as to block propagation of the malware through the network appliance.

16. The method of claim 1, wherein the protective measures include performing an action in respect of the common resource, wherein the action includes one or more of: reconfiguring the common resource; disconnecting the common resource; precluding access to the common resource by at least a subset of the computer systems in the network; and applying an anti-malware service to the common resource, so as to block propagation of the malware.

17. The method of claim 1, wherein each of the historical models and the forecast models is a graph data structure having computer systems as nodes and communications therebetween as edges.

18. A system comprising:
a processor and memory storing computer program code for blocking malware propagation in a network of computer systems by:
receiving, for each of a plurality of time periods, a historical model of the network of computer systems identifying communications between the computer systems and a malware infection state of each computer system;
generating, for each of a plurality of subsequent time periods, a forecast model of the network of computer systems in which each forecast model identifies communications between the computer systems and a malware infection state of the computer systems being determined based on an extrapolation of the historical models;
identifying a common resource in the network involved in propagation of the malware, the identification being based on changes to the malware infection states of the computer systems and the communications between the computer systems identified in the forecast models; and
implementing protective measures in respect to the common resource so as to block propagation of the malware through the network.

19. A non-transitory computer-readable storage element storing computer program code to, when loaded into a computer system and executed thereon, cause the computer system to block malware propagation in a network of computer systems by:
receiving, for each of a plurality of time periods, a historical model of the network of computer systems identifying communications between the computer systems and a malware infection state of each computer system;
generating, for each of a plurality of subsequent time periods, a forecast model of the network of computer systems in which each forecast model identifies communications between the computer systems and a malware infection state of the computer systems being determined based on an extrapolation of the historical models;
identifying a common resource in the network involved in propagation of the malware, the identification being based on changes to the malware infection states of the computer systems and the communications between the computer systems identified in the forecast models; and
implementing protective measures in respect to the common resource so as to block propagation of the malware through the network.
